(19) United States
(12) Patent Application Publication
(10) Pub. No.: US 2012/0233637 A1
(43) Pub. Date: Sep. 13, 2012

(54) METHODS AND SYSTEMS FOR FLEXIBLE VIDEO ON DEMAND

(75) Inventor: Kai Henniges, Zurich (CH)

(73) Assignee: Diva Video Access AG.

(21) Appl. No.: 13/043,042

(22) Filed: Mar. 8, 2011

(51) Int. Cl. H04N 7/025; G06Q 30/00

(52) U.S. Cl. 725/32; 705/14.46

(57) ABSTRACT

Systems and methods consistent with the invention relate to dynamically offering free-of-charge options for video-on-demand viewing of a media object on a user portal. According to one exemplary embodiment, a computer-implemented method may, upon a user request to view the media object, contact an advertisement server to determine the availability of a certain amount of advertisement revenue. When the available advertisement revenue exceeds a cost of presenting the media object, the method allows the user to select a free-of-charge option for viewing the media object or parts thereof and presents the media object to the user with advertisements. A portion of the media object and one or more pre-roll advertisements may be presented to the user prior to presentment of the free-of-charge option.

### TECHNICAL FIELD

The present disclosure relates to methods and systems for dynamically providing free-of-charge options to a video-on-demand (VOD) viewer.

### BACKGROUND

Video-on-demand (VOD) enables a user to view media objects, such as television shows or movies, upon request. Publishers may accomplish VOD by providing a download or by “streaming” the media object to the viewer. Streaming refers to continual transmission and reception over a data network, and may include buffering or other techniques to facilitate seamless transmission of the media object and, if desired, to allow for “trick modes” such as pause, fast-forward, and rewind options for the viewer. Providing streamed content over the internet or other networks can be expensive, as providers attempt to acquire sufficient downstream bandwidth, satisfy content owner licensing arrangements and ensure adequate content protection. Viewers' increasing demand for high definition programming further adds to this expense. In recent years, the availability of greater network bandwidth, increased internet access, improved data compression schemes, the availability of network-capable handheld mobile devices, and other advances have contributed to an increased popularity in streamed media objects.

Publishers such as AMAZON, VUDU, CINEMANOW, or NETFLIX make VOD available for payment via subscription, where a viewer has access to a fixed or unlimited number of media objects for one subscription price, or for payment on a per-object basis, where a viewer has access to only one media object for an associated price. Other publishers such as HULU, YOUTUBE, and BLINKX offer free viewing of media objects, but insert advertising to offset their costs and maintain profit.

In many instances, copyright holders make trailers available to prospective viewers, via publishers, free-of-charge and advertisement-free. Generally, however, publishers cannot profit from making an entire movie or television show available free-of-charge, to individual viewers, due at least in part to the high cost of streaming.

### SUMMARY

The present disclosure includes exemplary methods for dynamically offering a free-of-charge option for video-on-demand viewing of a media object on a user portal. In one embodiment, the method comprises determining advertisement availability contemporaneous with a user request, based on information received from at least one advertisement server. As disclosed herein, the user request may be a request for a listing of available free-of-charge media objects. The user request may also be a request to view a media object. The method further comprises calculating a profitability based on the determined availability of advertisements and calculating a cost of presenting the media object on the user portal. In addition, the method comprises causing, on the user portal, presentment of a first advertisement and a portion of the media object when the profitability exceeds a threshold value, and subsequently offering a free-of-charge option for viewing a second portion of the media object on the user portal. In the method, selection of the free-of-charge option results in presentment of the second portion of the media object and presentment of a second advertisement. In some embodiments, the second portion of the media object comprises a remainder of the media object, while in others, the second portion of the media object comprises less than a remainder of the media object.

In some embodiments, following the presentment of the second portion of the media object, the availability of advertisements is again determined, the profitability is again calculated, and when the profitability exceeds a threshold value, a second free-of-charge option for viewing a third portion of the media object is presented on the user portal, and when the second free-of-charge option is selected, the third portion of the media object and a third advertisement are presented.

Further, in some embodiments, the at least one advertisement server is configured to apply a set of conditions associated with a selected advertisement. The set of conditions may include a target audience, a frequency cap, and a budget. When the set of conditions is satisfied for the selected advertisement, the selected advertisement is deemed available. In some embodiments, information about the user at the user portal may be sent to the least one advertisement server.

In some embodiments, the information received from the at least one advertisement server is a revenue amount associate with available advertisements. Further, in some embodiments, the first advertisement is selected to achieve a revenue equal to or greater than a cost of presenting the first portion of the media object. As disclosed herein, a number of advertisements may be presented, and the number of advertisements may be selected to minimize the number of advertisements to achieve a selected revenue.

In some embodiments, a plurality of advertisement servers may be contacted at the time of the user request, and the information received from more than one of the plurality of advertisement servers may be used to calculate the profitability.

Embodiments of the invention also encompass computer systems, computer programs and computer readable medium, each comprising program code or instructions for dynamically offering a free-of-charge option for viewing a media object on a user portal. Such computer systems, computer programs and computer readable medium may be implemented according to the inventive methods and features disclosed herein.

In some embodiments, a system for dynamically offering a free-of-charge option for viewing a media object on a user portal comprises a calculation unit and a content server. The calculation unit may be configured to determine a cost of presenting the media object on the user portal, and to receive information regarding advertisement availability from least one advertisement server. The calculation unit may be further configured to calculate a profitability based on the received information and the cost of presenting the media object on the user portal. The content server may be configured to cause presentment of a first advertisement and a first portion of the media object to the user portal when the profitability exceeds a threshold value. The content server may be further configured to subsequently offer a free-of-charge option for further viewing of the media object on the user portal, and selection of the free-of-charge option may cause the content server to present a second advertisement and a second portion of the media object.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments consistent with the invention and together with the description, serve to explain the principles of the invention. In the drawings:

FIG. 1 illustrates an exemplary system for performing the principles of the inventions described herein.

FIG. 2 is an exemplary flow chart illustrating the operation of ad servers consistent with the present disclosure.

FIG. 3 is a flow chart illustrating an exemplary method of dynamically offering a free-of-charge option for VOD viewing of a media object consistent with the present disclosure.

FIG. 4 is a flow chart illustrating a second exemplary method of dynamically offering a free-of-charge option for VOD viewing of a media object consistent with the present disclosure.

### DESCRIPTION OF EXEMPLARY EMBODIMENTS

The following description refers to the accompanying drawings. Wherever possible, the same reference numbers will be used throughout the drawings to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Generally, a publisher may offer media objects on a pay-per-view (rental) or on a subscription basis to a viewer at a user portal. When sufficient advertisement revenue is available, however, the publisher may wish to change the business model made available to the viewer and offer a free-of-charge viewing option. Conceptually, one may think of the methods and systems described herein, as enabling dynamic updates to the business model made available to the viewer. Such methods and systems may allow the viewer to choose a business model from a single publisher, and to choose the business model on a per-use or per-media-object basis.

Within the concept of this specification, a “computer system” broadly refers to any stand-alone computer such as a PC, laptop, handheld media player, mobile phone, or series of computers connected via a network, and includes all internal processors, devices, memories, and functions. Additionally, a computer system includes any external devices or memories such as external drives, databases, or enterprise storage systems containing data and/or instructions accessed or used by the computer or series of computers. A computer system further includes any communication links between the computer(s) and external devices or memories and any communication links between the computers.

As used herein, a media object may be any video data object and may be, for example, a movie, television show, music video, or a portion thereof. A media object is typically in the format of a “file” that can be rendered by a video viewing software application. Such file types include, but are not limited to, AVI, MPG, MPEG, M1V, MP2, MP3, MPA, MPE, MPV2, ASF, WMA, WMV, IVF, RM, RA, RAM, MOV, and QT.

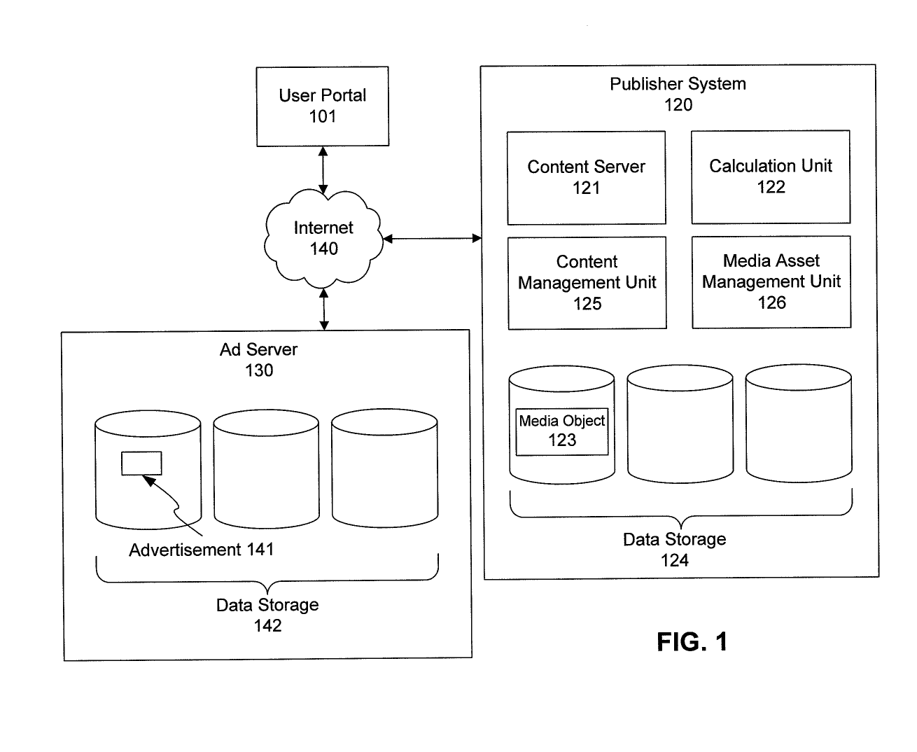

FIG. 1 illustrates an exemplary system for performing the principles of the inventions described herein. FIG. 1 shows an exemplary user portal 101. User portal 101 may be any computer system able to present media objects received over a network connection to a user/viewer. User portal 101 may be, for example, a set top box, a personal computer system, a game console, a mobile telephone, or a handheld electronic media player having an interface, such as a web browser or media player that implements a software application, via which a user can view media objects. Publisher system 120 may be any computer system configured to provide media objects across a network connection. Exemplary publisher system 120 includes content server 121, calculation unit 122, data storage devices 124, content management unit 125, and media asset management unit 126.

In exemplary publisher system 120, content server 121 may be configured to provide media objects across a network connection, for example via internet 140 to user portals such as user portal 101. Content server 121 may utilize at least one processor and memory from exemplary publisher system 120. Calculation unit 122 is a module implemented in hardware, software, or firmware, or in some combination thereof, to perform calculations on behalf of publisher system 120. Calculation unit 122 may be implemented as one or more modules within content server 121, or separately, using a separate processor and/or memory within publisher system 120.

Content management unit 125 and media asset management unit 126 are also modules implemented in hardware, software or firmware, or in some combination thereof, and may be implemented as one or more modules within content server 121, or separately, using a separate processor and/or memory within publisher system 120. Content management unit 125 may be responsible for various tasks relating to the management of media objects. For example, content management unit 125 may be used to configure how media objects are organized (e.g., according to genre) and how media objects are presented to the user portal 101 (e.g., in a listing of five media objects per page). Media asset management unit 126 may be responsible for the management and implementation of business rules associated with media objects. For example, media asset management unit 126 may be used to identify allowable uses or show-times for media objects under their associated license agreements. Media asset management unit 126 may be used, for example, to identify whether AVOD rights are associated with a media object, as discussed with respect to method 400 below.

Data storage devices 124 may comprise one or more memory devices that store data, such as, for example, random access memory (RAM), read-only memory (ROM), a magnetic storage device (e.g., a hard disk), an optical storage device (e.g., a CD- or DVD-ROM), an electronic storage device (e.g., EPROM or a flash drive), and/or another other data storage devices known in the art. Data storage devices 124 may contain media objects, such as media object 123, as well as other data. For illustrative simplicity, FIG. 1 shows one media object 123 in data storage 124. As one of ordinary skill in the art will recognize, data storage 124 may contain numerous media objects. Calculation unit 122 and content server 121 may utilize data stored in data storage 124 or other memory not shown in publisher system 120 to perform operations.

FIG. 1 shows an exemplary ad server 130 containing data storage 142. Data storage devices 142 may comprise one or more memory devices that store data, such as, for example, random access memory (RAM), read-only memory (ROM), a magnetic storage device (e.g., a hard disk), an optical storage device (e.g., a CD- or DVD-ROM), an electronic storage device (e.g., EPROM or a flash drive), and/or another other data storage devices known in the art. As one of ordinary skill in the art will recognize, data storage 142 may contain numerous advertisements. Ad server 130 is a computer system configured to store and provide advertisements, for example advertisement 141, across a network connection. More specifically, exemplary ad server 130 may be a web server that stores advertisements used in online marketing and delivers them to website visitors, such as a viewer utilizing user portal 101.

FIG. 1 shows user portal 101, publisher system 120, and ad server 130 connected to internet 140, which facilitates communication between the computer systems and with other computer systems not shown. Internet 140 may include one or more public or private wired or non-wired networks, or any combination thereof.

For purposes of explanation only, certain aspects and embodiments are described herein with reference to the exemplary components illustrated in FIG. 1. The functionality of the illustrated components may overlap, however, and may be present in a fewer or greater number of elements and components. Further, all or part of the functionality of the illustrated elements may co-exist or be distributed among several geographically-dispersed locations. For example, data storage 142 and data storage 124 may be external to ad server 130 and publisher system 120, respectively, and may potentially be in a different geographic location than other components of ad server 130 and publisher system 120. Further, the individual memory devices of data storage 142 and data storage 124 may be geographically dispersed. For another example, publisher system 120 and ad server 130, although shown as separate entities in FIG. 1, may be parts of the same entity and may be implemented using a single computer system. Moreover, embodiments, features, aspects and principles of the present invention may be implemented in various environments and are not limited to the illustrated environments.

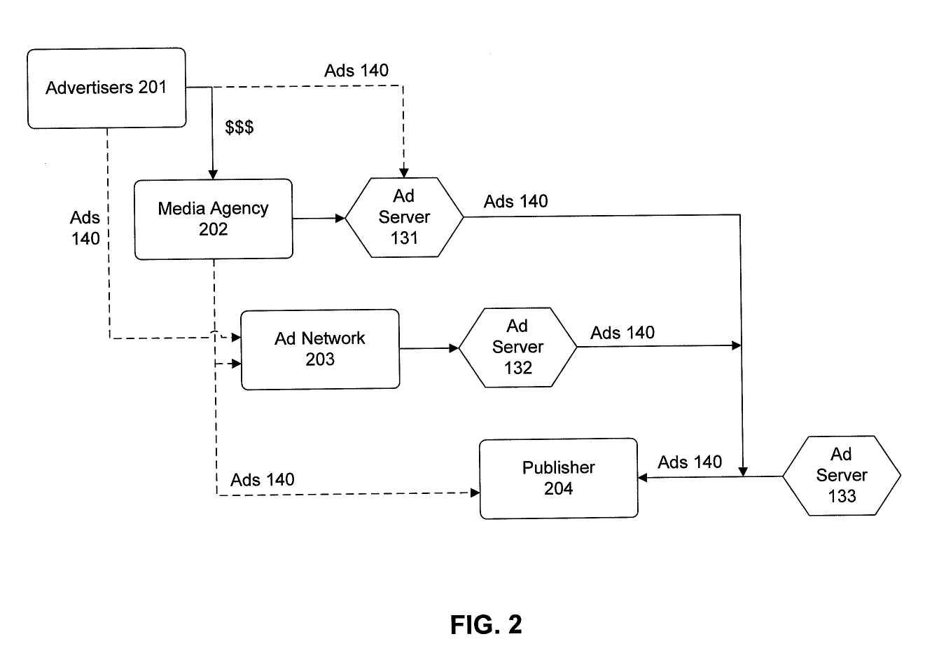

FIG. 2 shows some typical configurations of entities that create and/or distribute advertisements. In the exemplary embodiment of FIG. 2, publisher 204 receive information from ad servers 131, 132, or 133. For example, publisher 204 may receive information relating to the availability of advertisements at one or more of the advertisement servers 131, 132, or 133. In some embodiments, publisher 204 may receive such information upon request. Ad servers 131, 132 or 133 may also or alternatively provide such information without solicitation from publisher 204.

Advertisements from one or more of the ad servers 131, 132, and 133 may be used to fund one or more publisher's presentment of media objects to viewers at various user portals. In many embodiments, publisher 204 is an internet website or cable television provider, but may be any entity or group of entities that facilitate the presentment of media objects to viewers. Publisher 204 may, for example, own and run publisher system 120 as shown in FIG. 1. Publisher 204 may alternatively or additionally obtain such services from a third-party.

Generally, ad servers may be either local or remote with respect to publishers. Local ad servers are run by publishers themselves and generally supply advertisements only to the controlling publisher(s). A benefit to having a local ad server is that the ad server's advertisement content may be controlled by publishers. As shown in FIG. 2, exemplary ad server 133 is local ad server run by publisher 204 and would typically supply advertisements only to publisher 204. In some embodiments, ad server 133 may be configured to determine which of the “upstream” remote ad servers 131 and 132, for example, offer the most profitable ads. Remote ad servers allow advertisers and/or media agencies to have one central location for controlling distribution of their advertisements across multiple publishers. Exemplary remote ad servers 131 and 132 provide advertisements to multiple publishers, including publisher 204, for example. Typically remote ad servers are not run by publishers, but instead are run by third parties.

Each configuration shown in FIG. 2 is optional, and one of ordinary skill in the art will recognize that numerous alternate configurations are possible. In some configurations, advertisers 201 may create their own advertisements. Alternatively advertisers may work with one or more media agencies, such as media agency 202, to create advertisements, such as ads 140. Media agencies may indirectly provide ads to media outlets, such as publisher 204 for example, via ad servers, such as via ad server 131. Alternatively, media agencies or advertisers may provide advertisements directly to media outlets. In FIG. 2, ad network 203 represents a company that connects advertisers, for example advertisers 201, to web sites, for example, publisher 204, that want to host advertisements.

Generally, ad networks aggregate ad space supply from various publishers and match it with advertiser demand. In some embodiments, a publisher may advise one or more ad servers, such as ad servers 131 and 132, and/or one or more ad networks, such as ad network 203, that it has ad space available. The publisher may also, for example, advise one or more ad servers of characteristics of the available ad space. For example, publisher 204 may contact and advise ad network 203 that it has 15 minutes of ad space available and/or the type of advertisement that it is seeking to fill ad space (e.g., which types of products it would like to advertise, or which markets/localities the ads will show in). In response, ad network 203 may advise whether it can provide ads to fill this ad space. Such an exchange may be executed, for example, at stage 303 in method 300 or stage 406 of method 400, which are discussed in detail below. Ad networks may be “blind,” such that advertisers supply their ads to the ad networks, but would not necessarily know or control where their ads were placed. For example, advertisers 201 may supply its ads to ad network 203 and may not know that one of their ads 140 was used by publisher 204. Ad networks may, in such embodiments, after-the-fact provide a report to the publisher of where its ads were placed.

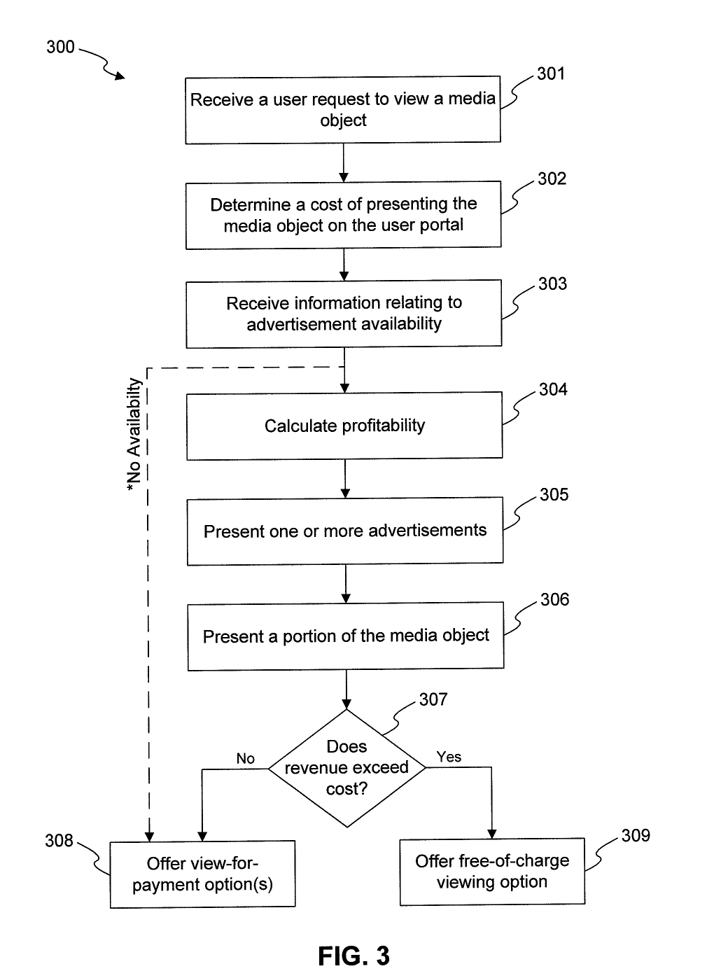

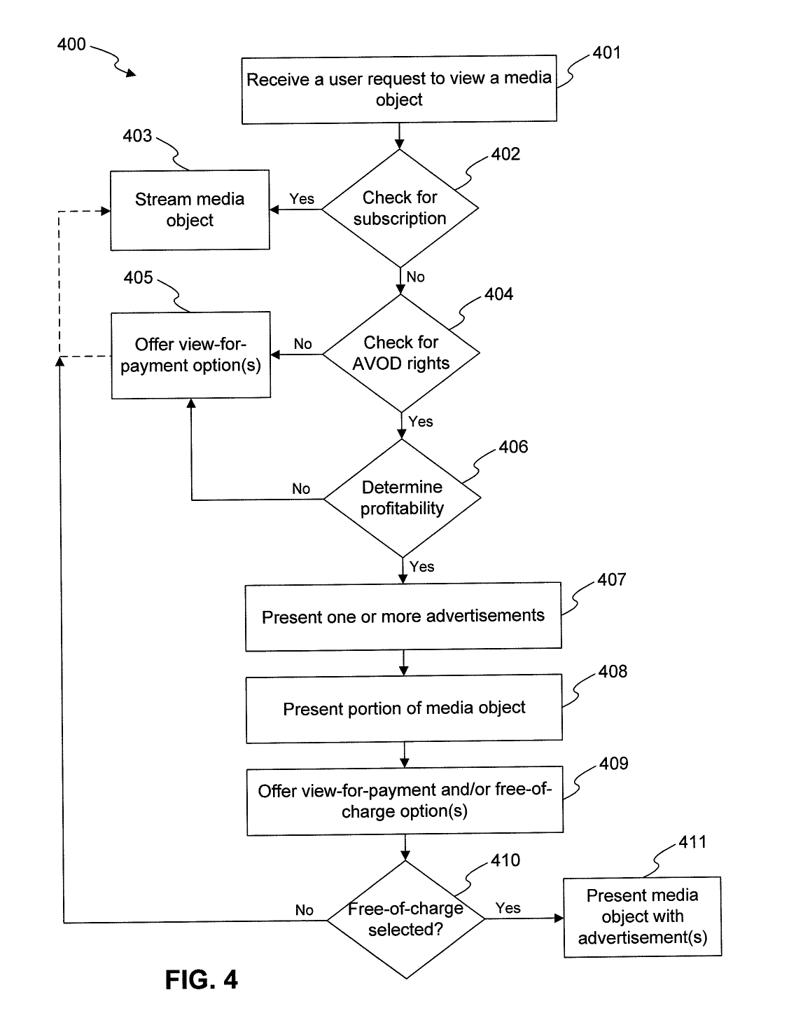

FIG. 3 and FIG. 4 illustrate exemplary methods 300 and 400 for dynamically offering a free-of-charge option for VOD viewing of a media object. Method 300 or 400 may be implemented, for example, by publisher system 120 to dynamically offer a free-of-charge option for VOD viewing of media object 123 to the user at user portal 101. Content server 121, calculation unit 122, content management unit 125, media asset management unit 126, or any sub-units thereof, may, together or separately perform one or more stages of method 300 or 400. One of ordinary skill in the art will appreciate that a single publisher system 120, as shown in FIG. 1, or a plurality of computer systems in a variety of configurations, may perform methods 300 or 400.

In some embodiments, publisher system 120 invokes method 300 or 400 when it receives a user request from user portal 101 to view a media object 123, as depicted in stage 301 of FIG. 3 and in stage 401 of FIG. 4. In at least one exemplary embodiment, the user may have logged into an application via an interface at user portal 101 and may have selected media object 123 for viewing on the user interface, causing the performance of stage 301 or causing the performance of stage 401. In some embodiments, publisher system 120 may invoke method 300 or 400 upon a user request for a listing of free-of-charge media objects available at the time of the user request. In such cases, the request for a listing is received in stage 301/401. Further, in some embodiments, publisher system 120 may invoke method 300 or 400 multiple times to accommodate a single user request. For example, a user may request a listing of free-of-charge media objects available for viewing at the time of the request, thereby invoking the method, and the method may be invoked again upon the user's selection of one of the media objects in the resultant listing.

In some embodiments, stages 302-307, and 308/309 may be repeated multiple times for a single user request to view a media object. For example, after each scene or chapter of a movie or at some other time(s), these stages may be repeated. Thus, in such embodiments the viewer would be given the option to continue viewing free-of-charge when that option is commercially viable (i.e., when condition 307 is satisfied).

As shown in FIG. 3, method 300 proceeds to stage 302 where a cost of presenting the media object on the user portal is determined. The cost (monetary) of presenting the media object typically includes at least a copyright license fee associated with the media object. In addition, the cost may include a presentment cost and an encryption cost. The presentment cost represents the cost to a publisher system to physically provide the media object to a user portal, for example over internet 140 to user portal 101, and may include fees from internet service providers who charge fees to publishers that wish to ensure sufficient bandwidth for sensitive transmissions. The encryption cost refers to the cost to secure the media object. Such encryption may, for example, prevent unauthorized interception, download, or re-transmission by computer systems other than user portal 101 or may prevent user portal 101 itself from performing some unauthorized use of media object 123, such as download or re-transmission of media object 123. One of ordinary skill in the art will appreciate that many other costs may be associated with a publisher's presenting of a media object on a user portal, such as hosting costs or costs relating to digital rights management. Further, any of the aforementioned exemplary costs, or other costs that would be apparent to one of ordinary skill in the art, may be associated with a particular media object, may be associated with a particular instance of presenting the media object, or may be apportioned from an aggregated cost. Combinations of such cost structures are also possible. In some embodiments, costs may be estimated based on historical averages. In other embodiments, costs may be actual costs or a combination of estimated and actual costs.

After cost is determined in stage 302, information relating to advertisement availability is received in stage 303. One of ordinary skill in the art will appreciate that stages 302 and 303 may be performed in any order, and that stages 302-304 may be performed after stages 305 and 306, and that stage 304 or stages 302-304 may be implemented as part of stage 307. In some embodiments, stages 305 and 306 may be performed at the request of the viewer at user portal 101. For example, a user may select an option to view a portion of the media object for free, and thus, stages 305 and 306 would be performed if that option is selected.

In stage 303, information relating to advertisement availability may be received from multiple ad servers, or from a single ad server, such as ad server 130. In some embodiments, a publisher system may contact one or more ad servers, and the information may be received in response to this contact. Numerous factors, examples of which are explained below, may influence advertisement availability. For one example, each advertisement typically has a revenue amount associated with it, such that a publisher receives that revenue amount if it uses that advertisement. Client budgets may influence the associated revenue, where, for example, some advertiser may offer $60 for 1,000 views of its advertisement, whereas another advertiser may offer $40 for 1,000 views of its advertisement. Generally, the associated revenue for the one or more advertisements stored or accessible by ad server 130 would influence advertisement availability, such that if a certain revenue could not be achieved, then advertisements may be deemed unavailable. An advertisement may also be deemed unavailable for other business reasons, for example, when the advertisement does not meet a competitive goal (e.g., a publisher may not wish to show its competitor's advertisements), or the advertisement does not meet the publisher's moral standards.

Each advertisement may further be associated with a set of conditions for the use of that advertisement. For example, an advertiser may wish to limit the number of times a single viewer sees the advertisement, and may associate a frequency cap with its advertisements. For another example, an advertiser may be targeting a particular audience. In such cases, the advertiser may specify certain target audience characteristics (e.g., gender, age, geographic location, particular interests). Ad server 130, for example, may be configured to apply a set of conditions associated with the advertisements when it determines which advertisements are available to publisher system 120. For example, advertisers 201 may specify conditions to the ad server 130, and ad server 130 would then use the conditions to select or limit advertisements made available to publisher system 120.

Publisher systems may provide information to ad servers that the ad server may use to apply a set of conditions. For example, in some embodiments, publisher system 120 may collect data, such as the aforementioned target audience characteristics, about its users and may provide this information to ad server 130 to facilitate the application of a set of conditions. Such collections may aggregate information relating to many users or may be on a per-user basis. When data is collected on a per-user basis, publisher system 120 may, for example, provide information to ad server 130 regarding a single user when seeking information regarding advertisement availability for potential video-on-demand presentation of a media object to that single user. In some embodiments, the set of conditions may be considered met due to the content of the media object rather than on actual user data. For example, if the media object 123 is a romantic comedy movie, ad server 130 may consider one or more target audience characteristics as having been met (e.g., gender=female), making the assumption that there is some correlation between some characteristic(s) of the media object and the target audience characteristic(s).

In some embodiments, in stage 303, the information relating to advertisement availability may be a quotation from one or more ad servers of the number of advertisements available and/or the amount of advertising revenue available to the publisher. In some embodiments, the information relating to advertisement availability may be the actual advertisements themselves. When ads are accessible by the publisher, it may then present the advertisements to a user portal at the appropriate time. In some embodiments, the advertisements may be presented from the one or more ad servers at the appropriate time.

In embodiments where a user requests a listing of free-of-charge media objects, stages 302-304 and 307 may be performed for each media object subject to listing. When condition 307 is satisfied for a media object, that object may be added to the listing.

Using the determined cost of presenting the media object from stage 302 and knowing the available revenue from available advertisements, as determined with information provided in stage 303, profitability is calculated in stage 304.

In some embodiments, publisher systems may provide a threshold revenue amount to one or more ad servers, such as the amount that would enable the publisher to realize a revenue equal to or greater than its cost. In such embodiments, an ad server may be configured simply to respond, in stage 303, with an acknowledgement that the revenue amount could be satisfied or with a refusal. Further, in some embodiments, in stage 302, multiple ad servers may provide information to a publisher system regarding advertisement availability. In such embodiments, the publisher may utilize the ad server that best meets its needs at the time (i.e. the one that offers the greatest profitability). In some embodiments, the publisher system may utilize multiple ad servers in sequence to meet its needs (i.e. to achieve profitability). In some embodiments, the publisher system may use a combination of pre-roll, mid-roll, and post-roll advertisements from one or more ad servers to meet its needs. A pre-roll advertisement is any advertisement that is presented to the viewer prior to the presentment of a media object. A pre-roll advertisement may be selected, for example, from among the available advertisements, and a post-roll advertisement is one shown following completion of the presentment of a media object. A mid-roll advertisement is an advertisement shown at some point during the presentment of the media object.

In some embodiments, a limit may be applied to the number of advertisements that may be used to satisfy the condition that revenue must exceed cost in stage 307. In this case, the cost may be considered to be a “threshold value.” For example, publisher 204 may wish to only present four mid-roll advertisements and thus, the revenue of $X must be satisfied with four advertisements. In this example, if ad server 130 determines that it has seven advertisements available and the combination of any four of them would not meet or exceed $X, then only viewing for payment may be offered. Such an offering may be made, for example, in stage 308. In some embodiments, stages 303 and/or 304 may be periodically performed until condition 307 can be satisfied, and when condition 307 is satisfied, the publisher may then provide the user with a notification that a free-of-charge viewing option is available at that time. In such embodiments, the user may decide that they wish to view the media object at that time, and stages 305 and 306 may be performed. In some embodiments, the entire media object may simply be presented with advertisements (by, for example, performing stage 411 of method 400 shown in FIG. 4 as described below) without the performance of stages 305 and 306.

In the exemplary methods 300 and 400 disclosed herein, advertisement revenue available to a publisher at the time that a user requests viewing of a media object is dynamically determined. As such, at any given time and for any given media object, the available advertisement revenue may vary. For example, on date A at time B, the available advertisement revenue to publisher 204 seeking to provide the media object 123 may be $30, but on date C at time D, it may be $20. Further, in embodiments where the ad server applies conditions to determine advertisement availability, as explained above, the dynamic advertisement revenue available to a publisher can further vary by user and such factors that may limit the use of certain advertisements according to their associated rules. For example, the user's location, the content of the media object, or other factors may limit. In embodiments where multiple ad servers provide information to a publisher, the publisher can utilize one or more of the multiple ad servers to achieve the desired profitability. For example, profitability may be calculated for each of the ad servers and compared, and, in stage 304, and the most profitable ad server may be selected, or advertisements may be aggregated from multiple ad servers to satisfy the condition in stage 307.

In stage 305, one or more advertisements is presented. The advertisement may be a pre-roll advertisement. For example, one or more pre-roll advertisements may be selected from those available at ad server 130 in FIG. 1 or from ads 140 at some other ad server (such as 131, 132, or 133 in FIG. 2). In some embodiments, advertisements are presented from an ad server directly to a user portal.

A publisher system may utilize a link redirecting the user portal to an advertisement on an ad server to accomplish presentment of advertisements. In some embodiments, advertisements may be streamed or downloaded from the publisher system to the user portal.

In stage 306, a portion of the media object is presented. The portion may be any logical unit of the media object, for example, a single chapter of a movie.

Typically, such chapters are 9-10 minutes in duration, but in some embodiments may be any length of time. By way of alternate examples, the portion of the media object may be a single scene or several scenes of a movie. Preferably, though not necessarily, the portion of the media object is the beginning of the media object, such that presentment of the portion of the media object entices the viewer to want to see the remainder of the media object. Further, a portion of the media object may be selected such that the cost of presenting the portion can be monetized. For example, presenting 1/10 of the media object may cost 1/10 of the cost to present the entire media object. Where the portion can be monetized, one or more advertisements may be selected to realize revenue that exceeds or matches the cost of presenting the portion. In some embodiments, the copyright holder or licensor of the media object may dictate the portion of the media object that may be presented at stage 306. The copyright holder or licensor of the media object may also, or alternatively, dictate portions of the media object that may not be presented at stage 306. In embodiments where stages 302-307, and 308/309 are repeated, the portion(s) of the media object presented at stage 306 are such that the viewer sees the portions in sequence.

One of ordinary skill in the art will appreciate that stages 305 and 306 together or separately can be optional, or even eliminated, in some embodiments. In embodiments where stages 305 and 306 are optional, stages 305 and 306 may be performed at the request of a viewer.

In stage 307, it is determined whether profitability exceeds the cost of presenting the media object. If the advertising revenue exceeds the cost, a free-of-charge viewing option may be presented to the viewer at in stage 309. If the profitability does not exceed the cost, one or more view-for-payment options may be offered to the viewer at stage 308. Such view-for-payment options may include, for example, an option to pay a subscription fee. With the subscription fee, a user can enter a subscription agreement that allows viewing of the media object and potentially other media objects. The payment options may also include a pay-per-view option, where the user can view only one media object, such as media object 123, a fixed number of times (usually once, and sometimes within a fixed time frame). In some embodiments, stage 308 is eliminated. When stage 308 is eliminated a message may be presented to the viewer that informs them that free-of-charge viewing is unavailable. In an exemplary embodiment where the user requests a listing of free-of-charge media objects, if the available advertising revenue does not exceed the cost, the media object may not be listed in the listing presented to the potential viewer. Further, stages 305 and 306 may be performed upon user selection of a particular media object from the listing of free-of-charge media objects.

In some embodiments, it may be determined, in stage 307, whether revenue is equivalent to or exceeds the cost. If revenue is equivalent to or exceeds the cost, stage 309 is performed.

In stage 309, a free-of-charge viewing option may be presented to the user. In some embodiments, view-for-payment options such as pay-per-view or subscriptions may also be offered in stage 309. One advantage to embodiments performing stage 306 is that even when a free-of-charge option is offered in stage 309, the user may be more likely to select a payment option so that they may view the media object advertisement-free after viewing the portion of the media object.

If the user selects a free-of-charge viewing option offered in stage 309, a publisher system may present the media object with advertisements on the user portal. In some embodiments, when a pre-roll advertisement and portion of the media object have already been presented in stages 305 and 306, only the remainder of the media object, with one or more advertisements, is presented following stage 309. In other embodiments, the portion may be presented again following stage 309. In some embodiments, the presentment following stage 309 may be accomplished using streaming techniques. In some embodiments, the presentment following stage 309 may be accomplished by providing a download. Advertisements may be shown prior to presenting the remainder of the media object, or as mid-roll advertisements that are shown during presentment of the media object. The mid-roll advertisements may require a temporary suspension of the media object's viewing during the presentment of the advertisements. Alternatively, advertisements may be shown in a combination of pre-roll, mid-roll, and post-roll advertisements.

In some embodiments, pre-roll, mid-roll, or mid-roll advertisements may be shown as an “overlay” to the media object in the same or in a separate interface. For example, advertisements may scroll at the bottom of the interface, similar to a stock-ticker, while the main view continues display the media object so that the advertising does not require a temporary suspension of the media object's presentment. Any combination of overlay and suspension may be used to present the advertisements.

Typically, a publisher system causes mid-roll advertisements to be presented periodically during the presentment of the media object. The period may be a fixed amount of time, or it may be some other logical division of the media object, such as following one or more chapter(s) of a movie. In some embodiments, more than one advertisement may be presented sequentially to a user, especially when advertisements are brief in duration. For example, three short advertisements may be shown at the end of each movie chapter, or one minute worth of advertisements (resulting in a variable number) may be shown at the end of each movie chapter. In addition, a publisher may seek to minimize the number of mid-roll advertisements presented to a user during the presentment of a media object. In exemplary method 300, this goal may be considered in stage 303 or in calculating profitability in stage 304. For example, a single high-revenue advertisement paying $X may be presented rather than two lower-revenue advertisements paying $X/2.

The exemplary embodiment shown in FIG. 4 demonstrates additional stages 402-405 that are not shown in the exemplary embodiment of FIG. 3, but which could optionally be added to method 300. Turning to FIG. 4, following the user request to view a media object in stage 401, method 400 proceeds to stage 402 where it checks for a subscription. As explained above, some business models allow a user to obtain a subscription for viewing certain media objects for a fixed price. For example, a subscription may grant the user rights to view a certain, or alternatively an unlimited number, of media objects per month for a fixed monthly fee. If the user has a subscription that allows viewing of the requested media object, method 400 proceeds to stage 403 the media object is presented to the user portal. If the subscription does not allow viewing of the requested media object, or if the user does not have a subscription, stage 404 is performed.

If a media object is associated with “AVOD rights,” that media object may be presented to a user financed by the presentment of advertising. Generally, the copyright holder or some other entity in the distribution chain dictates whether a media object is subject to AVOD rights in a license agreement. In stage 404, it is determined whether there are AVOD rights associated with the media object. Such determinations may be made, for example, through the use of media asset management unit 126 in FIG. 1.

When a media object is not subject to AVOD rights, a publisher system cannot present that media object free-of-charge with advertisements. Thus, in stage 405, one or more view-for-payment options, such as subscription, pay-per-view options, or outright purchase, may be offered to the user. Alternatively, the user may be advised that free-of-charge viewing is unavailable. If payment options are given, and if the user enters an appropriate subscription agreement or otherwise makes or agrees to make an appropriate payment, the media object may be presented in stage 403, for example by streaming or providing a download. In stage 403, the media object is presented without any advertisements. In some embodiments (not shown), one or more advertisements may be shown prior to presenting the media object in stage 403.

When the media object is associated with AVOD rights, profitability is determined in stage 406. Stage 406 may include the processes described above with respect to stages 303, 304, and 307. When there is no profitability in stage 406, for example, when the cost of presentment exceeds the available advertising revenue, a subscription and/or pay-per-view option may be offered in stage 405. In some embodiments, stage 405 may be eliminated and the user may be notified that no free-of-charge option is available.

When there is profitability in stage 406, one or more advertisements may optionally be presented in stage 407, followed by a portion of the media object in stage 408. In stage 409, view-for-payment options may be offered, which, when selected, would allow the user to view the media object, or a portion thereof, without advertisements. In stage 409, free-of-charge options may also be presented, which, when selected (in stage 410), result in the presentment of the media object, or the remainder of the media object with advertisements in stage 411. Presenting the media object with advertisements in stage 411 may involve presenting advertisements prior to presentment of the media object or may involve presenting advertisements as mid-roll, post-roll, or overlay advertisements as described above with respect to method 300.

In some embodiments, stages 406-410 and 411/403 may be performed multiple times during the presentiment of a media object, for example, after each scene or chapter of a movie, the profitability may be determined in stage 406. Thus, the viewer has the option to continue viewing free-of-charge while such viewing is commercially viable.

The order of stages shown in FIG. 4 is preferred, but stages 402, 404, and 406 may be performed in any order. Further, stages 407 and 408 together or separately can be optional, or even eliminated, in some embodiments. In some embodiments, stages 407 and 408 may be performed at the request of the viewer at user portal 101.

The sequences of events described in FIGS. 3, and 4 are exemplary and not intended to be limiting. Thus, other method steps may be used, and even with the methods depicted in these figures, the particular order of events may vary without departing from the scope of the present invention. Moreover, certain steps may not be present and additional steps may be implemented. Also, the processes described herein are not inherently related to any particular apparatus and may be implemented by any suitable combination of components.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for dynamically offering a free-of-charge option for video-on-demand viewing of a media object on a user portal, the method comprising:
determining advertisement availability contemporaneous with a user request, based on information received from at least one advertisement server;
calculating a profitability based on the determined availability of advertisements and a cost of presenting the media object on the user portal; and
causing, on the user portal, presentment of a first advertisement and a portion of the media object when the profitability exceeds a threshold value, and subsequently offering a free-of-charge option for viewing a second portion of the media object on the user portal,
wherein selection of the free-of-charge option results in presentment of the second portion of the media object and presentment of a second advertisement.

2. The method of claim 1, wherein the second portion of the media object comprises a remainder of the media object.

3. The method of claim 1,
wherein the second portion of the media object comprises less than a remainder of the media object, and
wherein following the presentment of the second portion of the media object, the availability of advertisements is again determined, the profitability is again calculated, and when the profitability exceeds a threshold value, a second free-of-charge option for viewing a third portion of the media object is presented on the user portal, and when the second free-of-charge option is selected, the third portion of the media object and a third advertisement are presented.

4. The method of claim 1, wherein the at least one advertisement server is configured to apply a set of conditions associated with a selected advertisement, wherein the set of conditions includes a target audience, a frequency cap, and a budget, and wherein when the set of conditions is satisfied for the selected advertisement, the selected advertisement is deemed available.

5. The method of claim 4, wherein the method further comprises sending information about the user at the user portal to the least one advertisement server.

6. The method of claim 1, wherein the user request is a request to view the media object.

7. The method of claim 1, wherein the user request is a request for a listing of available free-of-charge media objects.

8. The method of claim 1, wherein the information received from the at least one advertisement server is a revenue amount associated with available advertisements.

9. The method of claim 1, wherein the first advertisement is selected to achieve a revenue equal to or greater than a cost of presenting the first portion of the media object.

10. The method of claim 1, wherein the second advertisement comprises a number of advertisements and wherein the number of advertisements is selected to minimize the number of advertisements to achieve a selected revenue.

11. The method of claim 1,
wherein the method further comprises contacting a plurality of advertisement servers at the time of the user request, and
wherein the method further comprises using the information received from more than one of the plurality of advertisement servers to calculate the profitability.

12. A system for dynamically offering a free-of-charge option for viewing a media object on a user portal, the system comprising:
a calculation unit configured to determine a cost of presenting the media object on the user portal, and to receive information regarding advertisement availability from least one advertisement server, the calculation unit being further configured to calculate a profitability based on the received information and the cost of presenting the media object on the user portal;
a content server configured to cause presentment of a first advertisement and a first portion of the media object to the user portal when the profitability exceeds a threshold value, and wherein the content server is further configured to subsequently offer a free-of-charge option for further viewing of the media object on the user portal,
wherein selection of the free-of-charge option causes the content server to present a second advertisement and a second portion of the media object.

13. The system of claim 12, wherein the second portion of the media object comprises a remainder of the media object.

14. The system of claim 12,
wherein the second portion of the media object comprises less than a remainder of the media object,
wherein following the presentment of the second portion of the media object, the calculation unit is further configured to again receive information regarding advertising availability and to again calculate the profitability,
wherein the content server is further configured to offer a second free-of-charge viewing option for further viewing of the media object when the profitability exceeds the threshold value, and
wherein selection of the second free-of-charge option cause presentment of a third advertisement and a third portion of the media object.

15. The system of claim 12, wherein the information received from the at least one advertisement server is a revenue amount associated with available advertisements.

16. The system of claim 12, wherein the calculation unit is further configured to contact the at least one advertisement server at the time of the user request to determine advertisement availability.

17. The system of claim 16, wherein the user request is a request to view a media object.

18. The system of claim 16, wherein the user request is a request to view a listing of free-of-charge media objects.

19. A computer-readable medium comprising instructions for performing, when executed by a processor, dynamically offering a free-of-charge option for viewing a media object on a user portal, the method comprising:
determining advertisement availability contemporaneous with a user request,
based on information received from at least one advertisement server;
calculating a profitability based on the determined availability of advertisements and a cost of presenting the media object on the user portal; and
causing, on the user portal, presentment of a first advertisement and a portion of the media object when the profitability exceeds a threshold value, and subsequently offering a free-of-charge option for viewing a second portion of the media object on the user portal,
wherein selection of the free-of-charge option results in presentment of the second portion of the media object and presentment of a second advertisement.

20. The computer-readable medium of claim 18, wherein the second portion of the media object comprises a remainder of the media object.

21. The computer-readable medium of claim 19,
wherein the second portion of the media object comprises less than a remainder of the media object, and
wherein following the presentment of the second portion of the media object, the availability of advertisements is again determined, the profitability is again calculated, and when the profitability exceeds a threshold value, a second free-of-charge option for viewing a third portion of the media object is presented on the user portal, and when the second free-of-charge option is selected, a third portion of the media object is presented along with a third advertisement.
